(19) United States
(12) Patent Application Publication
(10) Pub. No.: US 2018/0062185 A1
(43) Pub. Date: Mar. 1, 2018

(54) System and Method for Generating Water and Electric Power

(71) Applicant: James Seefried, Dallas, TX (US)

(72) Inventor: James Seefried, Dallas, TX (US)

(21) Appl. No.: 15/691,489

(22) Filed: Aug. 30, 2017

Related U.S. Application Data
(60) Provisional application No. 62/381,506, filed on Aug. 30, 2016.

(51) Int. Cl. H01M 8/04007; C02F 1/16; C02F 1/04; B01D 3/10; B01D 3/00

(52) U.S. Cl. CPC H01M 8/04037; C02F 1/16; C02F 2103/08; B01D 3/10; B01D 3/007; C02F 1/043

(57) ABSTRACT

A system for generating electric power and water comprises a fuel cell stack and a burner positioned to heat the fuel cell stack. The fuel cell is configured to receive oxygen and natural gas and generating electric power. A vacuum vessel is configured to receive brine water and to receive heat from the fuel cell stack via a heat exchanger, to distill salt from water to generate water.

### CROSS-REFERENCE TO RELATED APPLICATIONS

This application claims the benefit of U.S. Provisional Application No. 62/381,506, filed Aug. 30, 2016, which application is hereby incorporated herein by reference, in its entirety.

### TECHNICAL FIELD

The invention relates generally to generating water and electric power.

### SUMMARY

The present invention provides a system for generating water and electric power. The system comprises a fuel cell stack and a burner positioned to heat the fuel cell stack. The fuel cell is configured for receiving oxygen and natural gas. A vacuum vessel is configured to receive brine water and to receive heat from the fuel cell stack via a heat exchanger.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWING

For a more complete understanding of the present invention, and the advantages thereof, reference is now made to the following description taken in conjunction with the accompanying schematic diagram of a system embodying features of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

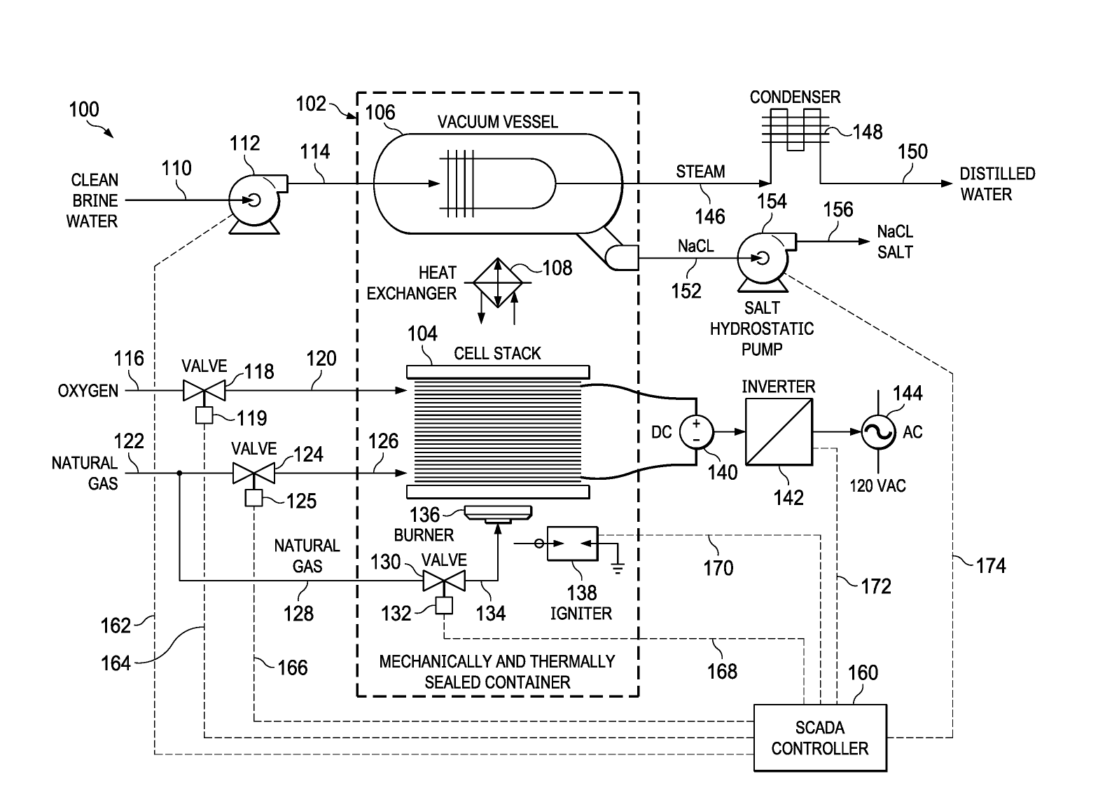

Referring to FIG. 1 of the drawings, a system 100 embodying features of the present invention includes a mechanically and thermally sealed container 102 having contained therein a fuel cell stack 104 and vacuum vessel 106. Fuel cell stack 104 comprises a number of individual fuel cells, each of which fuel cells contains an anode, a cathode, and an electrolyte layer. A hydrogen-rich fuel, such as clean natural gas or renewable biogas, enters the fuel cell stack, and it reacts electrochemically with oxygen (e.g., ambient air) to produce electric direct current, heat, and water. Fuel cell stacks are considered to be well-known in the art and will, therefore, not be discussed in further detail herein except in so far as necessary to describe the invention.

A line 116 configured for receiving oxygen is connected to a valve 118 which is connected to a line 120 connected to fuel cell stack 104. Valve 118 is controlled by actuator 119 in a manner described in further detail below. A line 122 configured for receiving fuel, such as natural gas, is connected to a valve 124 which is connected through line 126 to fuel cell stack 104. Valve 124 is controlled by actuator 125 in a manner described in further detail below.

A line 128 is connected from line 122 to a valve 130 which is connected through a line 134 to a burner 136 configured for providing heat to fuel cell stack 104. An actuator 132 is coupled to valve 130 for controlling valve 130 in a manner described in further detail below. Burner 136 is ignited by igniter 138 in a manner well-known in the art. Burner 136 is preferably a natural gas burner and is used not only to fire fuel cell stack 104, but preferably to also act as a catalytic converter for any CO₂ which may result from incomplete combustion of the natural gas coming in from line 134, thus rendering it a “no emission” product under EPA guidelines.

Fuel cell stack 104 is configured for generating electric power onto line 140 connected to inverter 142 configured for converting direct-current (DC) to alternating current (AC).

A line 110 is provided for receiving brine water, and is connected to a pump 112, which is connected via a line 114 to a vacuum vessel 106.

A heat exchanger 108 is provided within container 102 and is positioned and configured for transferring heat generated by fuel cell stack 104 to vacuum vessel 106.

A line 146 is connected to vacuum vessel 106 for transferring steam to a condenser 148, which is connected to an output line 150. A line 152 is connected to the vacuum vessel 106 for transferring salt to a salt hydrostatic pump 154, which is connected to an output line 156.

A Supervisory Control and Data Acquisition (“SCADA”) controller 160 is preferably provided to control operation of system 100. SCADA controller 160 is connected for receiving data and issuing commands on line 162 coupled to pump 112, on line 164 coupled to actuator 119, on line 166 coupled to actuator 125, on line 168 coupled to actuator 132, on line 170 coupled to igniter 138, on line 172 coupled to inverter 142, and on 174 coupled to pump 154. SCADA controllers are considered to be well known in the art and, therefore, will not be discussed in further detail herein, except insofar as necessary to describe the invention.

In operation, oxygen is received on line 116, and passes through valve 118 and line 120 to fuel cell stack 104. Fuel, preferably natural gas, enters the system on line 122 and passes through valve 124 and line 126 to fuel cell stack 104. Valves 118 and 124 are controlled by actuators 119 and actuator 125, respectively, both of which actuators 119 and 125 are controlled by SCADA controller 160 in a manner well known to those skilled in the art. Fuel on line 122 also passes through line 128, valve 130, and line 134 to burner 136, and valve 130 is controlled by actuator 132. Actuators 119, 125, and 132 are controlled by SCADA controller 160 in a manner well known in the art. When system 100 is starting up, SCADA controller 160 sends a command signal through line 170 to igniter 138 to ignite burner 136 to generate heat to operate fuel cell stack 104.

As fuel cell stack 104 operates, it generates DC to output 140. DC is preferably converted via inverter 142, controlled by SCADA controller 160, to a desired form of power, such as 120V AC at 144. Fuel cell stack 104 also generates heat which is transferred through heat exchanger 108 to vacuum vessel 106. Brine water enters the system on line 110 to pump 112 which pumps the water on line 114 to vacuum vessel 106. Heat transferred through heat exchanger 108 from fuel cell stack 104 to vacuum vessel 106 is effective for distilling steam from salt in the brine water. The steam is output on line 146 to condenser 148 which condenses the steam to distilled water which is output on line 150. The salt (typically NaCl) distilled from the water is output on line 152 to pump 154, controlled by SCADA controller 160, and salt is output on line 156 to a collection point (not shown).

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A system for generating electric power and water, the system comprising:
a fuel cell stack configured to receive oxygen and fuel and generate electric power;
a burner positioned to heat the fuel cell stack;
a vessel configured to receive brine water; and
a heat exchanger operative to transfer heat from the fuel cell stack to the vessel and separate water from salt.

2. The system of claim 1 wherein the fuel is natural gas.

3. The system of claim 1 wherein the vessel is a vacuum vessel.

4. The system of claim 1 wherein the vessel is a vacuum distillation vessel.
